(19) United States
(12) Patent Application Publication
(10) Pub. No.: US 2024/0152543 A1
(43) Pub. Date: May 9, 2024

(54) ASSISTIVE MEMORY RECALL

(71) Applicant: AT&T Intellectual Property I, L.P., Atlanta, GA (US)

(72) Inventors: Eric Zavesky, Austin, TX (US); James Pratt, Round Rock, TX (US); Zhengyi Zhou, Chappaqua, NY (US)

(21) Appl. No.: 18/053,742

(22) Filed: Nov. 8, 2022

(51) Int. Cl. G06F 16/435; G06F 16/438

(52) U.S. Cl. CPC G06F 16/436; G06F 16/438

(57) ABSTRACT

In one example, a method performed by a processing system including at least one processor includes detecting a need for assisted recall relating to an event in which a user was involved at a time in the past, identifying an instance of egocentric media stored in a library of egocentric media, wherein the instance of egocentric media matches the event in which the user was involved, modifying the instance of egocentric media to assist the user in recalling the event in which the user was involved, and presenting the instance of the egocentric media, as modified, to a user endpoint device of the user.

The present disclosure relates generally to immersive media, and relates more particularly to devices, non-transitory computer-readable media, and methods for providing stimuli to assist with memory recall.

### BACKGROUND

Memory is the faculty of the mind by which data or information is encoded, stored, and retrieved. Memory is often understood as an informational processing system with explicit and implicit functioning that is made up of three “types” of memory: sensory memory, short-term memory, and long-term memory. Sensory memory allows information from the outside world to be sensed in the form of chemical and physical stimuli and attended to various levels of focus and intent. Short-term memory serves as an encoding and retrieval processor. Long-term memory stores data through categorical models and systems.

### SUMMARY

In one example, the present disclosure describes a device, computer-readable medium, and method for providing stimuli to assist with memory recall. For instance, in one example, a method performed by a processing system including at least one processor includes detecting a need for assisted recall relating to an event in which a user was involved at a time in the past, identifying an instance of egocentric media stored in a library of egocentric media, wherein the instance of egocentric media matches the event in which the user was involved, modifying the instance of egocentric media to assist the user in recalling the event in which the user was involved, and presenting the instance of the egocentric media, as modified, to a user endpoint device of the user.

In another example, a non-transitory computer-readable medium stores instructions which, when executed by a processing system, including at least one processor, cause the processing system to perform operations. The operations include detecting a need for assisted recall relating to an event in which a user was involved at a time in the past, identifying an instance of egocentric media stored in a library of egocentric media, wherein the instance of egocentric media matches the event in which the user was involved, modifying the instance of egocentric media to assist the user in recalling the event in which the user was involved, and presenting the instance of the egocentric media, as modified, to a user endpoint device of the user.

In another example, a device includes a processing system including at least one processor and a computer-readable medium storing instructions which, when executed by the processing system, cause the processing system to perform operations. The operations include detecting a need for assisted recall relating to an event in which a user was involved at a time in the past, identifying an instance of egocentric media stored in a library of egocentric media, wherein the instance of egocentric media matches the event in which the user was involved, modifying the instance of egocentric media to assist the user in recalling the event in which the user was involved, and presenting the instance of the egocentric media, as modified, to a user endpoint device of the user.

### BRIEF DESCRIPTION OF THE DRAWINGS

The teachings of the present disclosure can be readily understood by considering the following detailed description in conjunction with the accompanying drawings, in which:

FIG. 1 illustrates an example system in which examples of the present disclosure may operate;

FIG. 2 illustrates a flowchart of an example method for building a media library to assist with memory recall in accordance with the present disclosure;

FIG. 3 illustrates a flowchart of an example method for providing stimuli to assist with memory recall in accordance with the present disclosure; and

FIG. 4 depicts a high-level block diagram of a computing device specifically programmed to perform the functions described herein.

To facilitate understanding, identical reference numerals have been used, where possible, to designate identical elements that are common to the figures.

### DETAILED DESCRIPTION

In one example, the present disclosure describes devices, non-transitory computer-readable media, and methods for providing stimuli to assist with memory recall. As discussed above, memory is the faculty of the mind by which data or information is encoded, stored, and retrieved. Memory is often understood as an informational processing system with explicit and implicit functioning that is made up of three “types” of memory: sensory memory, short-term memory, and long-term memory. Sensory memory allows information from the outside world to be sensed in the form of chemical and physical stimuli and attended to various levels of focus and intent. Short-term memory serves as an encoding and retrieval processor. Long-term memory stores data through categorical models and systems.

Perfect recall of events can often be difficult for people, due to various factors that may corrupt the manner in which information is encoded, stored, and/or retrieved in memory. For instance, memories such as the first song a person danced to with his or her partner, the name of a particular musician, or the first time that a person met an acquaintance or friend, can be difficult to retrieve from memory. The human brain uses various tactics to enable humans to more easily retrieve memories, such as redintegration and state dependent learning (in which small “chunks” of memory may trigger recall of an entire event, or body chemistry and state matching enable easier recall of information). Current human-created systems to assist with memory recall tend to rely on full-fledged playback of events. In other words, these systems “tell” a person what happened, rather than helping the person to recall on his or her own.

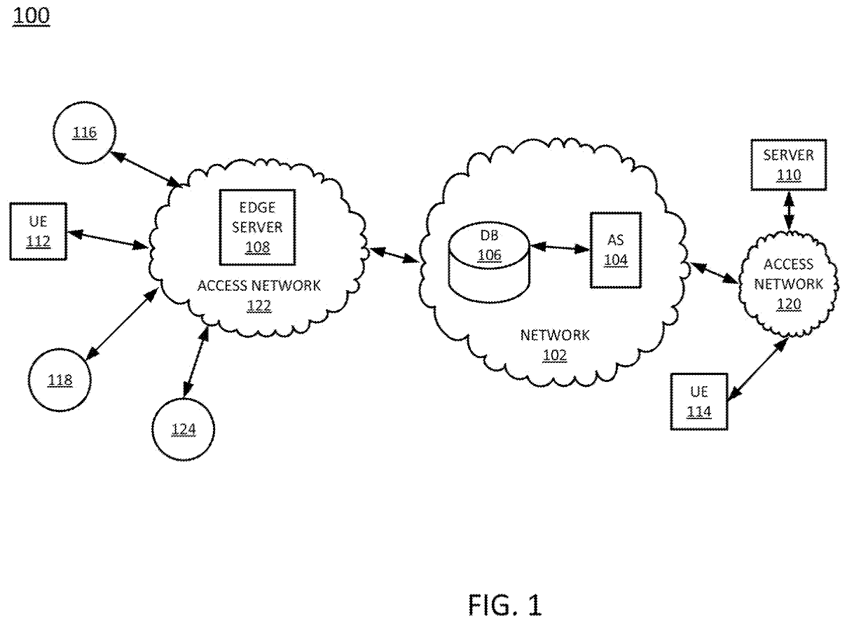

Examples of the present disclosure provide a system for assistive memory recall that provides one or more stimuli to a user in order to help the user recall an event. In one example, aspects of an event that may help a user to recall that event may be learned and leveraged to assist the user in overcoming memory recall obstacles. In a further example, the amount of stimuli provided to the user is minimized, so that a majority of the recall is user-driven. In some examples, effects such as visual and/or audio effects may be leveraged to evoke a mood in the user that is similar to a mood the user experienced when he or she experienced the event that is being recalled. In further examples, the same types of effects may be leveraged to align the mood of a playback of portions of the event with the user's current feelings about the event (e.g., where the user's feelings about the event may have changed since the event first occurred). These and other aspects of the present disclosure are described in greater detail below in connection with the examples of FIGS. 1-4.

To further aid in understanding the present disclosure, FIG. 1 illustrates an example system 100 in which examples of the present disclosure may operate. The system 100 may include any one or more types of communication networks, such as a traditional circuit switched network (e.g., a public switched telephone network (PSTN)) or a packet network such as an Internet Protocol (IP) network (e.g., an IP Multimedia Subsystem (IMS) network), an asynchronous transfer mode (ATM) network, a wireless network, a cellular network (e.g., 2G, 3G, and the like), a long term evolution (LTE) network, 5G and the like related to the current disclosure. It should be noted that an IP network is broadly defined as a network that uses Internet Protocol to exchange data packets. Additional example IP networks include Voice over IP (VoIP) networks, Service over IP (SoIP) networks, and the like.

In one example, the system 100 may comprise a network 102, e.g., a telecommunication service provider network, a core network, or an enterprise network comprising infrastructure for computing and communications services of a business, an educational institution, a governmental service, or other enterprises. The network 102 may be in communication with one or more access networks 120 and 122, and the Internet (not shown). In one example, network 102 may combine core network components of a cellular network with components of a triple play service network; where triple-play services include telephone services, Internet or data services and television services to subscribers. For example, network 102 may functionally comprise a fixed mobile convergence (FMC) network, e.g., an IP Multimedia Subsystem (IMS) network. In addition, network 102 may functionally comprise a telephony network, e.g., an Internet Protocol/Multi-Protocol Label Switching (IP/MPLS) backbone network utilizing Session Initiation Protocol (SIP) for circuit-switched and Voice over internet Protocol (VoIP) telephony services. Network 102 may further comprise a broadcast television network, e.g., a traditional cable provider network or an internet Protocol Television (IPTV) network, as well as an Internet Service Provider (ISP) network. In one example, network 102 may include a plurality of television (TV) servers (e.g., a broadcast server, a cable head-end), a plurality of content servers, an advertising server (AS), an interactive TV/video on demand (VoD) server, a streaming server, and so forth.

In one example, the access networks 120 and 122 may comprise broadband optical and/or cable access networks, Local Area Networks (LANs), wireless access networks (e.g., an IEEE 802.11/Wi-Fi network and the like), cellular access networks, Digital Subscriber Line (DSL) networks, public switched telephone network (PSTN) access networks, 3^{rd} party networks, and the like. For example, the operator of network 102 may provide a cable television service, an IPTV service, a streaming service, or any other types of telecommunication service to subscribers via access networks 120 and 122. In one example, the access networks 120 and 122 may comprise different types of access networks, may comprise the same type of access network, or some access networks may be the same type of access network and other may be different types of access networks. In one example, the network 102 may be operated by a telecommunication network service provider. The network 102 and the access networks 120 and 122 may be operated by different service providers, the same service provider or a combination thereof, or may be operated by entities having core businesses that are not related to telecommunications services, e.g., corporate, governmental or educational institution LANs, and the like.

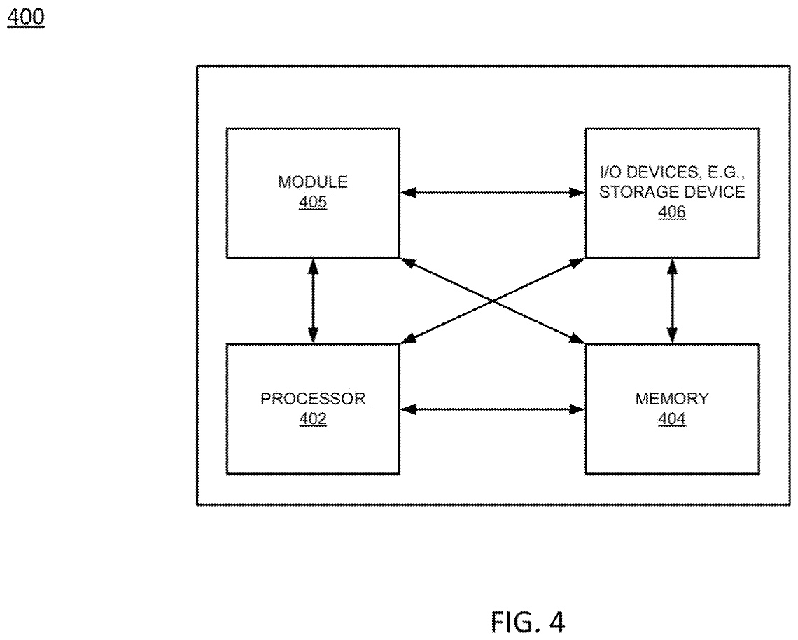

In accordance with the present disclosure, network 102 may include an application server (AS) 104, which may comprise a computing system or server, such as computing system 400 depicted in FIG. 4, and may be configured to provide one or more operations or functions in connection with examples of the present disclosure for providing stimuli to assist with memory recall. The network 102 may also include at least one database DB 106 that is communicatively coupled to the AS 104. For instance, the DB may maintain user profiles that store, for various users, instances of egocentric media, sensor readings captured contemporaneously with the instances of egocentric media, and other information, as discussed in greater detail below.

It should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 4 and discussed below) or multiple computing devices collectively configured to perform various steps, functions, and/or operations in accordance with the present disclosure. Thus, although only a single application server (AS) 104 and a single database (DB) 106 are illustrated, it should be noted that any number of servers and any number of databases may be deployed. Furthermore, these servers and databases may operate in a distributed and/or coordinated manner as a processing system to perform operations in connection with the present disclosure.

In one example, AS 104 may comprise a centralized network-based server for providing one or more stimuli to assist with memory recall. For instance, the AS 104 may host an application that collects egocentric media relating to a user, as well as biometric data of the user (which may be collected contemporaneously with the egocentric media). The AS 104 may analyze the egocentric media to recognize people, places, objects, music, sentiments, and the like. The AS 104 may also analyze the biometric data of the user in order to infer the user's mood and/or state of mind. The AS 104 may then associate metadata with the egocentric media, where the metadata may identify the recognized elements of the egocentric media (e.g., the people, places, objects, music, sentiments, and the like), the inferred mood or state of mind of the user, a time at which the egocentric media was captured, a location at which the egocentric media was captured, the user with whom the egocentric media is primarily associated, and/or other information about the egocentric media and the user's mood or state of mind at the time of the event(s) depicted in the egocentric media.

In the future, when the user is attempting to recall an event, the user may submit a query identifying details of the event to the AS 104. The AS 104 may match the details specified in the query to a stored instance of egocentric media associated with the user. For instance, the user's profile may be indexed to a library of egocentric media, such that the AS 104 can identify which instances of egocentric media out of a plurality of instances of egocentric media are primarily associated with the user. The AS 104 may then match the details specified in the query to metadata associated with a specific one of the instances of the egocentric media that are primarily associated with the user.

The AS 104 may further modify the specific one of the instances of egocentric media in order to facilitate recall of an event depicted in the specific one of the instances of egocentric media by the user. For instance, the AS 104 may add effects (e.g., visual effects, audio effects, etc.) in order to evoke a mood in the user that is similar to a mood the user felt at the time of the event being recalled (which may be indicated, for example, by metadata associated with the specific one of the instances of egocentric media). In another example, the AS 104 may add effects in order to soften or blunt the impact of the specific one of the instances of egocentric media on the user (e.g., where the user's feelings on the event depicted in the specific one of the instances of egocentric media may have changed over time). In further examples, the AS 104 may remove portions of the specific one of the instances of egocentric media in order to evoke a mood or soften an impact. The AS 104 may then present the specific one of the instances of egocentric media, as modified, to the user in order to assist the user in recalling the event depicted in the specific one of the instances of egocentric media.

In one example, AS 104 may comprise a physical storage device (e.g., a database server) to user profiles and/or a library of egocentric media. The library of egocentric media may comprise both various items of media content, such as still images, video (e.g., two dimensional video, three-dimensional video, 360 degree video, volumetric video, etc.), audio, text, and the like.

In one example, the DB 106 may store user profiles and/or a library of egocentric media, and the AS 104 may retrieve individual user profiles and/or instances of egocentric media from the 106 when needed. For ease of illustration, various additional elements of network 102 are omitted from FIG. 1.

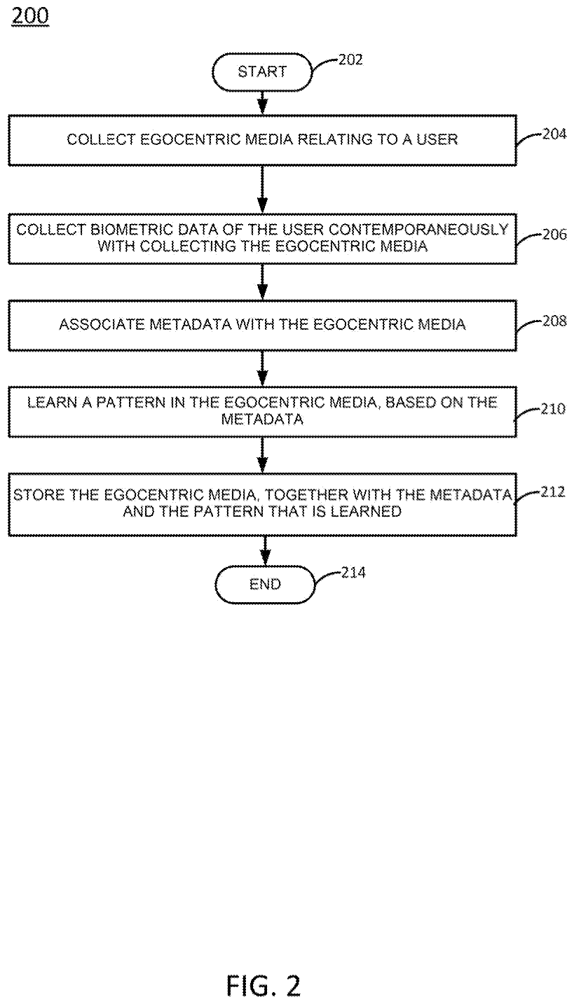

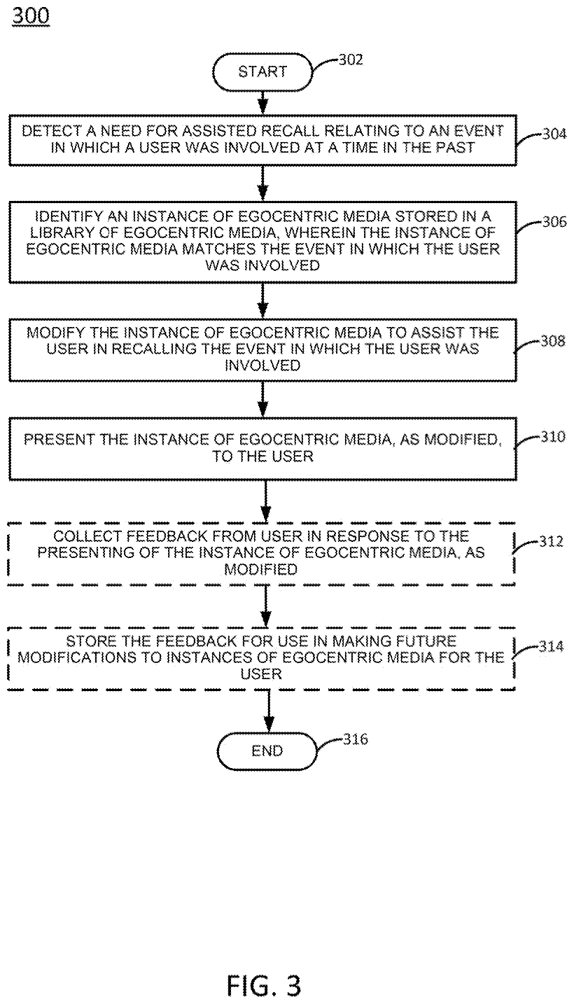

In one example, access network 122 may include an edge server 108, which may comprise a computing system or server, such as computing system 400 depicted in FIG. 4, and may be configured to provide one or more operations or functions for providing one or more stimuli to assist with memory recall, as described herein. For instance, an example method 200 for building a media library to assist with memory recall is illustrated in FIG. 2 and described in greater detail below, while an example method 300 for providing one or more stimuli to assist with memory recall is illustrated in FIG. 3 and described in greater detail below.

In one example, application server 104 may comprise a network function virtualization infrastructure (NFVI), e.g., one or more devices or servers that are available as host devices to host virtual machines (VMs), containers, or the like comprising virtual network functions (VNFs). In other words, at least a portion of the network 102 may incorporate software-defined network (SDN) components. Similarly, in one example, access networks 120 and 122 may comprise “edge clouds,” which may include a plurality of nodes/host devices, e.g., computing resources comprising processors, e.g., central processing units (CPUs), graphics processing units (GPUs), programmable logic devices (PLDs), such as field programmable gate arrays (FPGAs), or the like, memory, storage, and so forth. In an example where the access network 122 comprises radio access networks, the nodes and other components of the access network 122 may be referred to as a mobile edge infrastructure. As just one example, edge server 108 may be instantiated on one or more servers hosting virtualization platforms for managing one or more virtual machines (VMs), containers, microservices, or the like. In other words, in one example, edge server 108 may comprise a VM, a container, or the like.

In one example, the access network 120 may be in communication with a server 110. Similarly, access network 122 may be in communication with one or more devices, e.g., a user endpoint device 112, and access network 122 may be in communication with one or more devices, e.g., a user endpoint device 114. Access networks 120 and 122 may transmit and receive communications between server 110, user endpoint devices 112 and 114, application server (AS) 104, other components of network 102, devices reachable via the Internet in general, and so forth. In one example, the user endpoint devices 112 and 114 may comprise mobile devices, cellular smart phones, wearable computing devices (e.g., smart glasses, virtual reality (VR) headsets or other types of head mounted displays, or the like), laptop computers, tablet computers, Internet of Things (IoT) devices, or the like (broadly “extended reality devices”). In one example, each of the user endpoint devices 112 and 114 may comprise a computing system or device, such as computing system 400 depicted in FIG. 4, and may be configured to present modified instances of egocentric media in order to assist with memory recall.

In a further example, the access networks 120 and 122 may be in further communication with a plurality of sensors. For instance, the access network 122 may be in communication with sensors 116, 118, and 124. The sensors 116, 118, and 124 may be distributed throughout a location and may collect biometric data of a person who is present in the location, including images of the person (e.g., still and/or video images), audio of the person, and other data. Thus, the sensors 116, 118, and 124 may include cameras, microphones, radio frequency identification sensors, thermal sensors, pressure sensors, and/or other types of sensors. The sensors 116, 118, and 124 may comprise standalone sensors or may be integrated into Internet of Things (IoT) devices, such as smart security systems, smart lighting systems, smart thermostats, and the like.

Additionally, sensors that are integrated in the user endpoint devices 112 and 114 may also collect biometric data of users of the user endpoint devices 112 and 114. For instance, the sensors that are integrated in user endpoint devices may measure a user's pulse rate, a user's skin conductivity, a user's blood sugar level, a user's blood alcohol content, a user's blood oxygen level, a user's respiration rate, a user's body temperature, a user's blood pressure, and/or other biometrics. For instance, a sensor integrated in a smart watch may be able to measure the wearer's pulse rate or body temperature, while an Internet-connected insulin delivery system may be able to measure a wearer's blood sugar level.

In one example, server 110 may comprise a network-based server for providing stimuli to assist with memory recall. In this regard, server 110 may comprise the same or similar components as those of AS 104 and may provide the same or similar functions. Thus, any examples described herein with respect to AS 104 may similarly apply to server 110, and vice versa.

In an illustrative example, a system for providing stimuli to assist with memory recall may be provided via AS 104 and edge server 108. In one example, a user may engage an application on user endpoint device 112 to establish one or more sessions with an assistive recall system, e.g., a connection to edge server 108 (or a connection to edge server 108 and a connection to AS 104). In one example, the access network 122 may comprise a cellular network (e.g., a 4G network and/or an LTE network, or a portion thereof, such as an evolved Uniform Terrestrial Radio Access Network (eUTRAN), an evolved packet core (EPC) network, etc., a 5G network, etc.). Thus, the communications between user endpoint device 112 and edge server 108 may involve cellular communication via one or more base stations (e.g., eNodeBs, gNBs, or the like). However, in another example, the communications may alternatively or additional be via a non-cellular wireless communication modality, such as IEEE 802.11/Wi-Fi, or the like. For instance, access network 122 may comprise a wireless local area network (WLAN) containing at least one wireless access point (AP), e.g., a wireless router. Alternatively, or in addition, user endpoint device 112 may communicate with access network 122, network 102, the Internet in general, etc., via a WLAN that interfaces with access network 122.

It should also be noted that the system 100 has been simplified. Thus, it should be noted that the system 100 may be implemented in a different form than that which is illustrated in FIG. 1, or may be expanded by including additional endpoint devices, access networks, network elements, application servers, etc. without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements. For example, the system 100 may include other network elements (not shown) such as border elements, routers, switches, policy servers, security devices, gateways, a content distribution network (CDN) and the like. For example, portions of network 102, access networks 120 and 122, and/or Internet may comprise a content distribution network (CDN) having ingest servers, edge servers, and the like for packet-based streaming of video, audio, or other content. Similarly, although only two access networks, 120 and 122 are shown, in other examples, access networks 120 and/or 122 may each comprise a plurality of different access networks that may interface with network 102 independently or in a chained manner. In addition, as described above, the functions of AS 104 may be similarly provided by server 110, or may be provided by AS 104 in conjunction with server 110. For instance, AS 104 and server 110 may be configured in a load balancing arrangement, or may be configured to provide for backups or redundancies with respect to each other, and so forth. Thus, these and other modifications are all contemplated within the scope of the present disclosure.

To further aid in understanding the present disclosure, FIG. 2 illustrates a flowchart of an example method 200 for building a media library to assist with memory recall in accordance with the present disclosure. In one example, the method 200 may be performed by an application server, such as the AS 104 or server 110 illustrated in FIG. 1. However, in other examples, the method 200 may be performed by another device, such as the processor 402 of the system 400 illustrated in FIG. 4. For the sake of example, the method 200 is described as being performed by a processing system.

The method 200 begins in step 202. In step 204, the processing system may collect egocentric media relating to a user.

Within the context of the present disclosure, “egocentric” media refers to media that primarily depicts a specific person (or user). While individual items of egocentric media may also depict other people with whom the specific person has interacted, each item of egocentric media will, at a minimum, depict the specific person. For instance, if the egocentric media comprises a plurality of video clips, each video clip of the plurality of video clips may depict User A. Additionally, User B, User C, and User D may be depicted in subsets of the plurality of video clips (where each subset may represent fewer than all of the plurality of video clips). User B, User C, and User D may be friends, family members, or acquaintances of User A or may simply be other people with whom User A interacted but with whom User A has no long-standing relationship.

In one example, the egocentric media may comprise a plurality of different types of media collected from a plurality of different sources or sensors that are in communication with the processing system. In each instance, the egocentric media may capture some event or interaction with which the user was involved. For instance, in one example, the egocentric media may comprise video footage from a video camera (e.g., a body camera worn by the user, a security camera in the user's vicinity, a camera operated by another individual, etc.). In another example, the egocentric media may comprise a series of interactions the user had with another individual (e.g., a sequence of social media postings, a sequence of text messages or emails, etc.). In another example, the egocentric media may comprise an audio recording (e.g., a recording of a phone call involving the user, a recording of a presentation made by the user, etc.). In another example, the egocentric media may comprise still images.

In one example, the user has opted-in to the collection of the egocentric media. That is, the user has explicitly provided his or her permission for the egocentric media to be recorded and collected. In a further example, any other individuals depicted in the egocentric media may also provide explicit permission for the egocentric media to be recorded and collected. In a further example, any egocentric media that is collected in step 204 may be encrypted to protect the privacy of any individuals depicted in the egocentric media.

In step 206, the processing system may collect biometric data of the user contemporaneously with collecting the egocentric media.

For instance, as discussed above, a plurality of sensors that are present in the location from which the egocentric media is being collected may also collect the biometric data. The sensors may be distributed throughout the location and may include sensors that are integrated into one or more endpoint devices of the user.

The biometric data that is collected may include one or more of: a measure of the user's pulse rate, a measure of the user's skin conductivity, a measure of the user's blood sugar level, a measure of the user's blood alcohol content, a measure of the user's blood oxygen level, a measure of the user's respiration rate, a measure of the user's body temperature, a measure of the user's blood pressure, and/or other biometrics.

In step 208, the processing system may associate metadata with the egocentric media.

For instance, in one example, each item of egocentric media may be associated with a timestamp or metadata indicating the time at which the event or interaction depicted in the egocentric media occurred. In a further example, each item of egocentric media may be further associated with metadata indicating a location at which the event or interaction depicted in the egocentric media occurred. In a further example, other metadata that may be associated with an item of egocentric media may indicate at least one of: the identities of one or more individuals depicted in the egocentric media (where the identities may be determined, for instance, using facial recognition techniques, voice recognition techniques, recognition of social media handles, mobile phone numbers, or email addresses, or the like), an overarching sentiment or mood of the event or interaction depicted in the egocentric media (e.g., happy, sad, surprised, etc.), and/or an identification of a type of event coinciding with the event or interaction depicted in the egocentric media (e.g., a concert, a vacation, a party, a work meeting, a class at a school, or the like, where the coinciding event may be determined from a calendar entry of the user, detection of the event in video, audio, or text of the egocentric media, or by other means).

In a further example, the metadata may relate to biometric data of the user that were captured together with the egocentric media, as discussed above. The metadata may further relate to a mood or state of mind that the processing system has inferred from the biometric data (e.g., a pulse rate that is more than a threshold above a baseline pulse rate may indicate stress, fear or nervousness, a blood alcohol content that is higher than a threshold value may indicate disorientation, etc.). In some examples, the biometric data may be used to “work backwards” in the egocentric media in order to locate content within the egocentric data that may be considered to be reliable or unreliable (e.g., if the biometric data associated with a portion of the egocentric media indicates possible disorientation of the user, then the portion of the egocentric media, or at least the user's recollection of the portion of the egocentric media, may be considered unreliable or less reliable relative to other portions of the egocentric media). In a further example, the metadata may relate to an identity of the user (e.g., a name, a unique number or another identifier that allows egocentric media relating to the same user to be identified and linked).

In step 210, the processing system may learn a pattern (or multiple patterns) in the egocentric media, based on the metadata.

For instance, the processing system may use the metadata to index the egocentric media. This indexing may result in a plurality of clusters of egocentric media that share some commonality with each other. For instance, different clusters of egocentric media may relate to the user's friends, the user's family, the user's job or school, or the like. Similarly, different clusters of egocentric media may depict events or interactions that were serious, funny, or the like, or in which the user was a passive or active participant. Based on these clusters, the processing system may learn what subjects are most important to the user. For instance, if the user posted twenty times as many photos of the user's dog to a social media account as the user did of his or her own car, this may indicate that the user considers the user's dog to be more important to him or her than the car. The clusters may also help the processing system to detect anomalies. For instance, the user may have posted twenty photos of food to a social media account over time, but a most recent food photo may include the user's friends as well as the food, which may indicate that the most recent food photo is more “important” than the previous food photos. In one example, the clusters may be augmented with biometrics of the user, as discussed above.

In one example, the metadata associated with the egocentric media may be updated to reflect the pattern(s) that is learned. For instance, metadata associated with an instance of egocentric media could indicate a specific pattern (or cluster) that the instance of egocentric media reflects, or that the instance of egocentric media represents an anomalous event that contradicts a learned pattern.

In step 212, the processing system may store the egocentric media, together with the metadata and pattern(s) that is learned.

For instance, the processing system may have access to a library of egocentric media. The metadata may be used as an index into the library which allows the processing system to retrieve specific instances of the egocentric media for recall, as discussed in further detail below in connection with FIG. 3. Thus, having performed steps 204-212, the processing system may build a library of egocentric media for the user, where the library of egocentric media has optionally been enhanced and indexed to facilitate retrieval of specific instances of egocentric media by an assisted recall process. Thus, method 200 can be executed for a plurality of different users.

The method 200 may end in step 214.

To further aid in understanding the present disclosure, FIG. 3 illustrates a flowchart of an example method 300 for providing one or more stimuli to assist with memory recall in accordance with the present disclosure. In one example, the method 300 may be performed by an application server, such as the AS 104 or server 110 illustrated in FIG. 1. However, in other examples, the method 300 may be performed by another device, such as the processor 402 of the system 400 illustrated in FIG. 4. For the sake of example, the method 300 is described as being performed by a processing system.

The method 300 may begin in step 302. In step 304, the processing system may detect a need for assisted recall relating to an event in which a user was involved at a time in the past (i.e., where the “past” is relative to the time at which the need for the assisted recall is detected).

In one example, the need for the assisted recall may be detected when the user explicitly submits a query relating to the event in which the user was involved. For instance, the user may voice a verbal query, type a text query into a search bar of a graphical user interface, or submit the query in another form. In one example, the query may include a specification of a time range for the event in which the user was involved (e.g., “July 2019,” “last Christmas,” “between May 1 and May 29, 2014,” “last summer NYC trip,” or the like).

In another example, the query may include information about a current mood or emotional state of the user. For instance, the query may include readings from sensors that are in communication with the processing system. The sensors may include, for instance, sensors that are distributed throughout a physical location in which the user is currently present (including sensors integrated in user endpoint devices such as mobile phones, wearable devices, IoT devices, and the like). For instance, the sensors might include a video or still camera or a microphone in a room in which the user is present, a fitness tracker or health monitor that the user is wearing, or another type of sensor. The readings from the sensors might include facial expressions of the user, a tone of voice of the user or a statement made by the user, a pulse rate of the user, a skin conductivity of the user, a blood sugar level of the user, a blood alcohol content of the user, a blood oxygen level of the user, a respiration rate of the user, a body temperature of the user, a blood pressure of the user, or any other metrics from which the user's mood or emotional state can be inferred (e.g., an image of the user crying implies a sad mood, an increased respiration rate implies nervousness or fright, audio of the user laughing implies a happy mood, an image of the user frowning implies an unhappy or angry mood, etc.).

In another example, the query may include contextual information about the event in which the user was involved. For instance, the contextual information may include a (typed or spoken) keyword or search phrase (e.g., a description of the event, a name of another person involved in the event, etc.), or an image related to the event (e.g., an image of another person, an image of a location, an image of an object, etc.).

In step 306, the processing system may identify an instance of egocentric media stored in a library of egocentric media, wherein the instance of egocentric media matches the event in which the user was involved.

As discussed above, egocentric media comprises media that primarily depicts the user (and may optionally also depict other people or objects with whom the specific user interacted). An instance of egocentric media may comprise a still image, video footage, a sequence of social media postings, a sequence of text messages, a sequence of emails, an audio recording, or another type of media.

To identify an instance of egocentric media that matches the event in which the user was involved, the processing system may, in one example, match information in a query provided by the user to metadata describing the instance of egocentric media. For instance, timestamp metadata associated with the instance of egocentric media may indicate a time that falls within a time range specified in the query (e.g., a timestamp of “Dec. 25, 2021” would match a specified time range of “last Christmas”). Additionally, the current mood of the user, as inferred from sensor data included in the query, may match metadata describing the mood or tone of the instance of egocentric media.

In another example, the processing system may solicit further input from the user in order to identify the instance of egocentric media. For instance, in one example, the processing system may ask the user to provide further details to assist in identifying an instance of egocentric media that matches the event in which the user was involved (e.g., other individuals who may have been involved in the event, objects (e.g., a birthday cake, a gift, etc.) involved in the event, a location of the event, or other further details). In another example, the processing system may identify multiple instances of egocentric media that may match the event in which the user was involved, and may present excerpts (e.g., thumbnail images, video clips, audio clips, or the like) of the multiple instances of egocentric media to the user so that the user may select one instance from among the multiple instances of egocentric media.

In step 308, the processing system may modify the instance of egocentric media to assist the user in recalling the event in which the user was involved.

In one example, the modification to the instance of egocentric media may include a modification to a mood or tone of the instance of egocentric media in order to evoke in the user a mood that is consistent with a mood of the user during the time at which the event in which the user was involved occurred. For example, the instance of egocentric media may relate to a mild injury that the user sustained during an accident that was considered funny at the time that the accident happened. However, in hindsight, elements of the accident may be frightening or less funny than remembered. In this case, the processing system may add visual and/or audio effects (e.g., music, adding audio noise, lowering the volume of specific speakers, lighting effects, blurring, softening or brightening of the color scheme, etc.) to or may remove parts of the instance of egocentric media in order to preserve the mood of the user at the time that the accident happened.

In another example, after determining that biometric data associated with the instance of egocentric media is anomalous (e.g., either from the initial capture by the system in step 208 or from determination of the current user state in step 306), the processing system may modify content of the instance of egocentric media to indicate an appropriate warning or screening of content. In one instance, if captured or analyzed data indicates that the user was extremely excited (e.g., raised endorphin levels are detected in correlation with egocentric data depicting a monumental win during a competition or winning a lottery), the instance of egocentric media may be altered with banners, color changes, or other celebratory embellishments.

In another instance, if captured or analyzed data indicates an anomalous condition (e.g., inebriation, disorientation, nervousness), the system may apply warnings corresponding to the egocentric media (e.g., “this content captured under an impaired state”) or the correlated biometric data (e.g., “this content is being reviewed in an impaired state”) to further inform the user of potential factual discrepancies. In yet another instance, if the original instance of egocentric media is being utilized for factual recall of a specific event (e.g., during a legal proceeding, an introspection of liability, etc.), these modifications by the system may be enforced or required by context (e.g., under oath, governance review, etc.) of the user.

In another example, the modification to the instance of egocentric media may include a modification to a mood or tone of the instance of egocentric media in order to evoke in the user a mood that is consistent with a current mood of the user, where the current mood of the user may be different from the mood of the user during the time at which the event in which the user was involved occurred. For instance, the instance of egocentric media may relate to an argument that the user had with a friend, and about which the user was very angry at the time that the argument happened. Over time, however, the user may have become less angry about the argument. Thus, in this case, the processing system may add visual and/or audio effects (e.g., music, adding audio noise, lowering the volume of specific speakers, lighting effects, blurring, softening or brightening of the color scheme, etc.) to or may remove parts of the instance of egocentric media in order to present a mood that is more consistent with the user's current feelings about the argument.

In another example, the modification to the instance of egocentric media may include extracting scenes or sequences of the instance of egocentric media that are pertinent to a current context of the user. For instance, if the user is currently in the company of their children, and the instance of egocentric media relates to a family vacation, the processing system may extract scenes or sequences of the instance of egocentric media that involve or are believed to be most interesting to the children. Portions of the instance of egocentric media that are not extracted may be removed from the instance of egocentric media (e.g., not used for presentation as discussed in further detail below in connection with step 310).

In another example, the modification to the instance of egocentric media may include removing scenes or sequences of the instance of egocentric media that are associated with a negative mood or sentiment. For instance, metadata associated with the scenes or sequences may indicate that, at the time the scenes or sequences were happening, the user was sad, angry, embarrassed, or the like.

In another example, the modification to the instance of egocentric media may include a modification that enhances an existing mood or tone of the instance of egocentric media. For example, where the instance of egocentric media depicts an event having a funny tone, audio and/or visual effects may be added to the instance of egocentric media in order to enhance this funny tone. For instance, an audio effect of a person or people laughing could be added to the instance of egocentric media.

In another example, a modification of the instance egocentric media may comprise summarizing the instance of egocentric media, e.g., as a sequence of highlights. For instance, if the instance of egocentric media comprises a video of the user's wedding reception, the modification might include extracting short scenes from the video that depict key moments from the reception (e.g., first dance, cake cutting, speeches, etc.).

Thus, in some examples, the modification to the instance of egocentric media may result in a modified copy of the instance of egocentric media that contains less than all of the original or default copy of the instance of egocentric media (e.g., fewer than all scenes or dialogue, or the same number of scenes and dialogue but with certain visual or audio elements masked or removed). The modified copy may include further elements that are added, or were not present in the original or default copy of the instance of egocentric media. In one example, for portions of the instance of egocentric media that were not present in the original or default copy of the instance of egocentric media (e.g., portions or elements that were added), the processing system may provide notifications or annotations to fully inform the user of externally provided media (e.g., “a portion of this media was added from an external source”).

It should be noted that, in one example, any modifications made to the instance of egocentric media in step 308 may be reversible. That is, the modifications may not permanently alter a default or master copy of the instance of the egocentric media. However, a separate, modified copy of the instance of egocentric media may be saved in addition to the default or master copy.

In step 310, the processing system may present the instance of the egocentric media, as modified, to the user.

In one example, the instance of egocentric media, as modified, may be presented on a user endpoint device, e.g., a private playback device (e.g., just for the user). For example, the instance of egocentric media, as modified, may be presented on a head mounted display or an augmented reality headset (if there is a visual element) or on a media player that is connected to a set of wired or wireless headphones (if there is only an audio element). In another example, the instance of egocentric media, as modified, may be presented on a non-private playback device (e.g., for group viewing). For example, the instance of egocentric media, as modified, may be presented on a video display such as a television set or monitor.

In optional step 312 (illustrated in phantom), the processing system may collect feedback from the user in response to the presenting of the instance of egocentric media, as modified.

In one example, the feedback may be explicit feedback. For instance, the user may provide an explicit rating of the instance of egocentric media, as modified (e.g., “like” or “dislike,” a numerical rating on a scale from 1-10 or zero to five stars, etc.). The user may also provide more specific feedback pertaining to what elements of the instance of egocentric media the user did or did not like. For instance, the user may type or speak feedback such as “I couldn't understand Eric over the music,” or “I forgot how funny that was.”

In another example, the feedback may be implicit feedback. For instance, the user may operate a control device to skip through portions of the presentation of the instance of egocentric media, as modified (where it may be assumed that the portions that the user skips through are not as important to the user as the portions the user did not skip through). Similarly, if the user operates the control device to replay portions of the presentation of the instance of egocentric media, as modified, it may be assumed that the portions that the user replays are considered by the user to be most important.

In further examples, user images, audio, and biometrics collected from sensors that are in proximity to the user during the presentation may allow the processing system to infer the user's mood or sentiment during the presentation (e.g., to determine whether the user enjoyed or did not enjoy various scenes or sequences of the instance of egocentric media, as modified). For instance, an audio clip of the user laughing during the presentation of a specific scene may indicate that the user found the specific scene to be funny, while a video clip of the user grimacing during the presentation of another specific scene may indicate that the user found the other specific scene to be uncomfortable.

In a further example, the inferred mood or sentiment of the user during the presentation of the instance of egocentric media, as modified, may be compared to the mood or sentiment of the user (if known) during the time that the event depicted in the instance of egocentric media, as modified, actually occurred. If there is a discrepancy between the inferred mood or sentiment of the user during the presentation of the instance of egocentric media, as modified, and the mood or sentiment of the user during the time that the event depicted in the instance of egocentric media, as modified, actually occurred, then future further modifications to the instance of egocentric media may be contemplated. For instance, if the user's mood at the time that the event occurred was angry, but the user's mood during presentation of the instance of egocentric media depicting the event was fondness, then the processing system may determine that less extensive modifications to the instance of egocentric media may be necessary during future presentations of the instance of egocentric media.

In some examples, a copy of the instance of egocentric media, as modified, may be stored (i.e., including the modifications). This may allow the instance of egocentric media to be easily retrieved with the same modifications, saving future processing time.

In optional step 314 (illustrated in phantom), the processing system may store the feedback for use in making future modifications to instances of egocentric media for the user.

For instance, as discussed above, the processing system may learn what types of modifications the user likes or does not like, and may extrapolate these preferences to the modification of other instances of egocentric media as well as future presentations of the instance of egocentric media that was presented (as modified) in step 310. These preferences may also be extrapolated to the modification of other (e.g., non-egocentric) media as well.

The feedback may be stored, for example, in a profile for the user, where the profile may also be indexed to instances of egocentric media associated with the user (and stored in a library).

The method 300 may end in step 316.

In one example, the processing system may identify to the user the modifications that are made to the instance of egocentric media. For instance, when the instance of egocentric media, as modified, is presented to the user, a list of the modifications may also be presented (e.g., in a separate file, in-line with the instance of egocentric media, as modified, or in some other way). In this way, the modifications may be made transparent to the user.

Examples of the present disclosure may be used to assist with recall for user's who are experiencing varying degrees of memory loss (e.g., a user can prepare a sequence of instances of egocentric media to assist an elderly friend or family member in remembering loved ones). Examples of the present disclosure can also be used to assist with improving user mood (e.g., a user may prepare a sequence of instances of egocentric media representing happy memories when the user is feeling unhappy).

In some cases, examples of the present disclosure may be used to facilitate video playback as a summary that is modified based on dialogue that is spoken in the present. For instance, a user may verbally request the review of a video summary of the events of a specific weekend. In other cases, examples of the present disclosure may be used to facilitate playback redintegration (e.g., recalling a memory by playing back smaller components of the memory).

Although not expressly specified above, one or more steps of the method 200 or method 300 may include a storing, displaying and/or outputting step as required for a particular application. In other words, any data, records, fields, and/or intermediate results discussed in the method(s) can be stored, displayed and/or outputted to another device as required for a particular application. Furthermore, operations, steps, or blocks in FIG. 2 or FIG. 3 that recite a determining operation or involve a decision do not necessarily require that both branches of the determining operation be practiced. In other words, one of the branches of the determining operation can be deemed as an optional step. However, the use of the term “optional step” is intended to only reflect different variations of a particular illustrative embodiment and is not intended to indicate that steps not labelled as optional steps to be deemed to be essential steps. Furthermore, operations, steps or blocks of the above described method(s) can be combined, separated, and/or performed in a different order from that described above, without departing from the examples of the present disclosure.

FIG. 4 depicts a high-level block diagram of a computing device specifically programmed to perform the functions described herein. For example, any one or more components or devices illustrated in FIG. 1 or described in connection with the method 200 or the method 300 may be implemented as the system 400. For instance, a server (such as might be used to perform the method 200 or the method 300) could be implemented as illustrated in FIG. 4.

As depicted in FIG. 4, the system 400 comprises a hardware processor element 402, a memory 404, a module 405 for providing one or more stimuli to assist with memory recall, and various input/output (I/O) devices 406.

The hardware processor 402 may comprise, for example, a microprocessor, a central processing unit (CPU), or the like. The memory 404 may comprise, for example, random access memory (RAM), read only memory (ROM), a disk drive, an optical drive, a magnetic drive, and/or a Universal Serial Bus (USB) drive. The module 405 for providing one or more stimuli to assist with memory recall may include circuitry and/or logic for performing special purpose functions relating to assistive memory recall. The input/output devices 406 may include, for example, a camera, a video camera, storage devices (including but not limited to, a tape drive, a floppy drive, a hard disk drive or a compact disk drive), a receiver, a transmitter, a speaker, a display, a speech synthesizer, an output port, and a user input device (such as a keyboard, a keypad, a mouse, and the like), or a sensor.

Although only one processor element is shown, it should be noted that the computer may employ a plurality of processor elements. Furthermore, although only one computer is shown in the Figure, if the method(s) as discussed above is implemented in a distributed or parallel manner for a particular illustrative example, i.e., the steps of the above method(s) or the entire method(s) are implemented across multiple or parallel computers, then the computer of this Figure is intended to represent each of those multiple computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computer or any other hardware equivalents, e.g., computer readable instructions pertaining to the method(s) discussed above can be used to configure a hardware processor to perform the steps, functions and/or operations of the above disclosed method(s). In one example, instructions and data for the present module or process 405 for providing one or more stimuli to assist with memory recall (e.g., a software program comprising computer-executable instructions) can be loaded into memory 404 and executed by hardware processor element 402 to implement the steps, functions or operations as discussed above in connection with the example method 200 or example method 300. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 405 for providing one or more stimuli to assist with memory recall (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of example only, and not limitation. Thus, the breadth and scope of a preferred example should not be limited by any of the above-described example examples, but should be defined only in accordance with the following claims and their equivalents.

What is claimed is:

1. A method comprising:
detecting, by a processing system including at least one processor, a need for assisted recall relating to an event in which a user was involved at a time in the past;
identifying, by the processing system, an instance of egocentric media stored in a library of egocentric media, wherein the instance of egocentric media matches the event in which the user was involved;
modifying, by the processing system, the instance of egocentric media to assist the user in recalling the event in which the user was involved; and
presenting, by the processing system, the instance of the egocentric media, as modified, to a user endpoint device of the user.

2. The method of claim 1, wherein the instance of egocentric media comprises an instance of media that primarily depicts the user.

3. The method of claim 2, wherein the instance of egocentric media comprises at least one of: a still image, a video footage, a sequence of social media postings, a sequence of text messages, a sequence of emails, or an audio recording.

4. The method of claim 1, wherein the detecting comprises receiving a query from the user that includes a specification of a time range for the event in which the user was involved.

5. The method of claim 4, wherein the query further includes information about a current mood of the user.

6. The method of claim 4, wherein the query further includes contextual information about the event in which the user was involved.

7. The method of claim 1, wherein the identifying comprises selecting the instance of egocentric media from among a plurality of instances of egocentric media stored in the library of egocentric media.

8. The method of claim 7, wherein the selecting comprises matching information in a query provided by the user to metadata describing the instance of egocentric media.

9. The method of claim 1, wherein the modifying comprises at least one of: modifying a visual effect or modifying an audio effect to the instance of egocentric media.

10. The method of claim 9, wherein the modifying comprises modifying a tone of the instance of egocentric media in order to evoke in the user a mood that is consistent with a mood of the user during the time in the past at which the event in which the user was involved occurred.

11. The method of claim 9, wherein the modifying comprises modifying a tone of the instance of egocentric media in order to evoke in the user a mood that is consistent with a current mood of the user, wherein the current mood of the user is different from a mood of the user during the time in the past at which the event in which the user was involved occurred.

12. The method of claim 1, wherein the modifying comprises extracting one or more scenes of the instance of egocentric media that are pertinent to a current context of the user.

13. The method of claim 1, wherein the modifying comprises removing one or more scenes of the instance of egocentric media that are associated with a negative sentiment.

14. The method of claim 1, wherein the modifying results in a modified copy of the instance of egocentric media that contains less than all of an original copy of the instance of egocentric media.

15. The method of claim 14, wherein the modified copy is stored as a separate copy from the original copy, without permanently modifying the original copy.

16. The method of claim 1, further comprising:
collecting, by the processing system, feedback from the user in response to the presenting of the instance of egocentric media, as modified; and
storing, by the processing system, the feedback for use in making a future modification to another instance of egocentric media for the user.

17. The method of claim 16, wherein the future modification is made in response to a discrepancy between an inferred mood of the user during the presentation of the instance of egocentric media, as modified and a mood of the user during the time in the past of the event in which the user was involved.

18. The method of claim 17, wherein the inferred mood is inferred from the feedback, and the mood of the user during the time in the past of the event in which the user was involved is known from metadata associated with the instance of egocentric media.

19. A non-transitory computer-readable medium storing instructions which, when executed by a processing system including at least one processor, cause the processing system to perform operations, the operations comprising:
detecting a need for assisted recall relating to an event in which a user was involved at a time in the past;
identifying an instance of egocentric media stored in a library of egocentric media, wherein the instance of egocentric media matches the event in which the user was involved;
modifying the instance of egocentric media to assist the user in recalling the event in which the user was involved; and
presenting the instance of the egocentric media, as modified, to a user endpoint device of the user.

20. A device comprising:
a processing system including at least one processor; and
a computer-readable medium storing instructions which, when executed by the processing system, cause the processing system to perform operations, the operations comprising:
detecting a need for assisted recall relating to an event in which a user was involved at a time in the past;
identifying an instance of egocentric media stored in a library of egocentric media, wherein the instance of egocentric media matches the event in which the user was involved;
modifying the instance of egocentric media to assist the user in recalling the event in which the user was involved; and
presenting the instance of the egocentric media, as modified, to a user endpoint device of the user.
